(19) United States
(12) Patent Application Publication
(10) Pub. No.: US 2011/0315231 A1
(43) Pub. Date: Dec. 29, 2011

(54) FLOW CONTROL DEVICE USING A DIAPHRAGM

(76) Inventor: Sergei Petrov, Seaham (GB)

(21) Appl. No.: 12/863,176

(22) PCT Filed: Jan. 16, 2009
(86) PCT No.: PCT/GB2009/050032

§ 371 Date: Sep. 20, 2011

(30) Foreign Application Priority Data
Jan. 18, 2008 (GB) 0800973.0

(51) Int. Cl. F15D 1/00

(52) U.S. Cl. 137/14; 137/67; 137/15.01

(57) ABSTRACT

A flow control device comprises an inlet side; an outlet side; and a sealing member between the inlet and the outlet side. A diaphragm selectively opens or closes or control a degree of closure of an opening between the inlet and the outlet sides depending on the proximity of the diaphragm to the sealing member. The diaphragm comprises a first portion of one side of the diaphragm exposed to the inlet side fluid pressure and a second portion of the same side of the diaphragm exposed to the outlet side fluid pressure and the opposite side of the diaphragm exposed to a control fluid pressure. The movement of the diaphragm between the open and closed states is governed by the inlet, outlet and control pressures which cause deformation of the diaphragm.

This invention relates to flow control devices, and particularly to flow control devices (for example valves) using a diaphragm for controlling fluid flow.

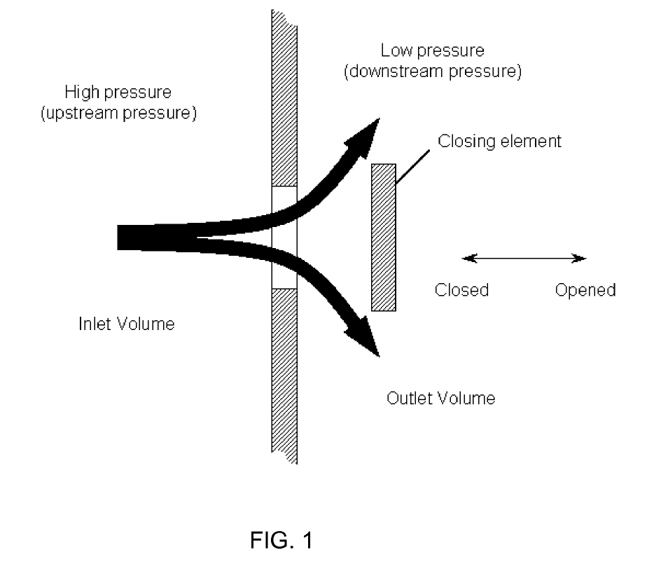

Traditionally, in all control valves, an element that closes the path for liquid media, such as a closing disc or diaphragm (closing element), moves against a stream of liquid media. The closing element approaches an upstream area of the valve when it closing. When the valve is opening, the closing element is moved away from the upstream area and its movement is assisted by the stream, i.e. the element is “pushed away” from closing orifice. Thus, the closing element and its supporting mechanism is located generally in the area with lower downstream pressure. This configuration is shown in FIG. 1.

A problem with this kind of valve design generally is that the mechanism holding the valve closing element must be very rigid, as the closing element is held against the fluid flow path in the closed position. In the open valve position, the closing element can also be exposed to high flow rates that can cause a significant turbulence. The result is that valve designs using a traditional arrangement of movement of closing element have a number of components, and also require the use of high strength metal elements to provide the required reliability and stability. Usually, these designs have parts that slide against each other that require lubrication, and this is difficult to achieve in some applications, for example in the water industry. In water industry applications, there are also solid deposits on all pipe walls and valve parts that can affect the correct valve operation for valves with mechanical moving parts, especially in the long term.

There is therefore a need for a simplified valve design with minimum moving parts and that will have a stable and reliable operational performance.

According to the invention, there is provided a flow control device, comprising: an inlet side; an outlet side; a sealing member between the inlet and the outlet side; and a diaphragm,

wherein the diaphragm selectively opens or closes or control a degree of closure of an opening between the inlet and the outlet sides depending on the proximity of the diaphragm to the sealing member,

wherein the diaphragm comprises a first portion of one side of the diaphragm exposed to the inlet side fluid pressure, a second portion of the same side of the diaphragm exposed to the outlet side fluid pressure and the opposite side of the diaphragm exposed to a control fluid pressure, wherein the movement of the diaphragm between the open and closed states is governed by the inlet, outlet and control pressures which cause deformation of the diaphragm.

This design uses a flexible diaphragm to provide the sealing function, and it is controlled by pressure differences within the device. The opening of the valve comprises deformation of the diaphragm, so that movable solid components for guiding the movement of a valve such as a sealing disc are not required. This design enables a low component count and simple assembly.

The flow control device preferably comprises a valve with an inlet and an outlet, wherein the valve comprises:

a sealing member on a first side of the diaphragm, wherein the inlet and the outlet are both on the first side of the diaphragm on opposite sides of the sealing member;

a control chamber provided on the opposite, second side of the diaphragm,

wherein the diaphragm is deformable between a first position in which a pressure in the control chamber corresponding to the inlet pressure urges a portion of the membrane against the sealing member, and a second position in which the inlet pressure urges the portion of the membrane away from the sealing member to couple the inlet and outlet.

The valve can be controlled by connecting the control chamber to the inlet or outlet of the valve, so than the valve will be in a closed or opened state.

This example of the invention thus provides a valve design in which a fluid inlet and fluid outlet are both on a first side of a diaphragm on opposite sides of a sealing point. A control chamber behind the diaphragm controls the deforming of the diaphragm between a first position in which a pressure in the control chamber urges a portion of the diaphragm against the sealing member, and a second position in which the inlet pressure urges the portion of the diaphragm away from the sealing member to couple the fluid inlet and fluid outlet.

The membrane preferably comprises a reinforced elastomer. Kevlar, carbon fiber, Zylon or other reinforcing materials can be used.

The membrane is preferably fixed at its ends, and the intermediate portion can deform towards and away from the sealing member.

In one example, the membrane can be formed as a bowl shape with a rigid upper outer rim and a rigid lower inner rim, and a flexible membrane connecting the rims. This provides a component that can simply be dropped into place. The sealing member can then be around the outside of the bowl. The fluid inlet is around the outside of the bowl above the sealing member, and the fluid outlet is around the outside of the bowl below the sealing member.

A guide member can sit inside the bowl for controlling the deformation of the flexible membrane. The-bowl shaped membrane collapses to move away from the sealing member, and this collapse can be controlled by the guide member to give the desired flow characteristics. The guide member can comprise a rigid surface against which the flexible membrane collapses.

In another example, the diaphragm comprises a flexible part and a rigid part, wherein the rigid part makes contact with the sealing member in the closed state of the device. Thus, the diaphragm can be a composite element. The inlet side and outlet side can be defined by a first annular passageway within a second annular passageway. This design can be bidirectional, so that the inlet can be the inner passageway or the outer passageway. The rigid part can then comprise a lid for closing the first annular passageway. This then provides a closure between the inlet and outlet.

In either design, a control valve is preferably provided for selectively coupling the fluid inlet or outlet to the control chamber.

The invention also provides a method of assembling a flow control device, comprising:

providing a casing defining two terminals that can act as an inlet and an outlet, and a sealing member;

lowering a cup-shaped membrane into the case, the membrane defining a control chamber inside the cup and the fluid inlet and outlet on the outside of the cup separated by the sealing member.

The invention also provides a method of controlling fluid flow between an inlet and an outlet, comprising:

controlling the pressure in a control chamber, thereby to deform a diaphragm between first and second positions, wherein a sealing member, the inlet and the outlet are on a first side of the membrane, and the control chamber is on an opposite side of the diaphragm,

wherein the diaphragm is deformed between a first position in which a pressure in the control chamber urges the a portion of the diaphragm against the sealing member, and a second position in which the inlet pressure urges the portion of the diaphragm away from the sealing member to couple the inlet and outlet.

Examples of the invention will now be described with reference to the accompanying drawings, in which:

FIG. 1 is used to explain the principle of operation of known valves;

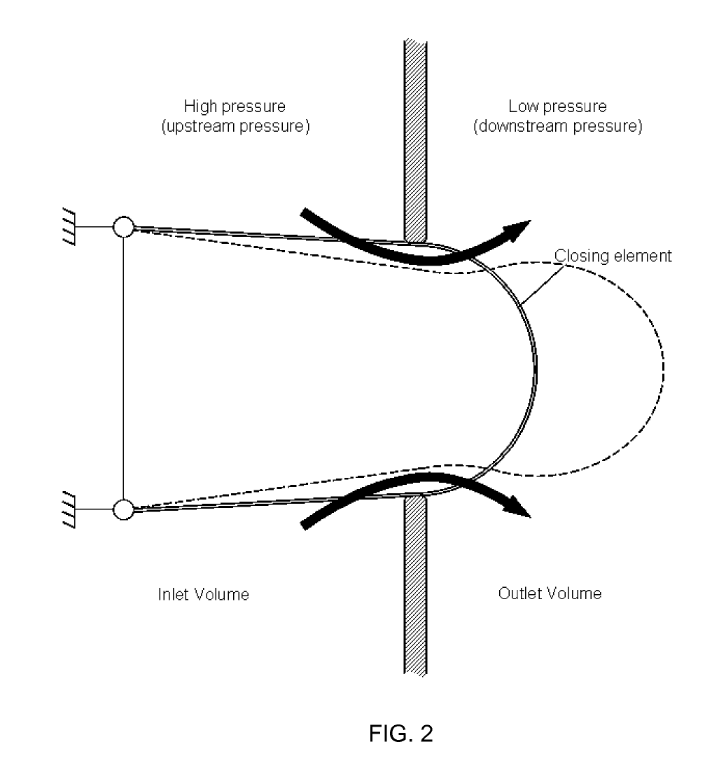

FIG. 2 is used to explain the principle of operation of the valve of the invention;

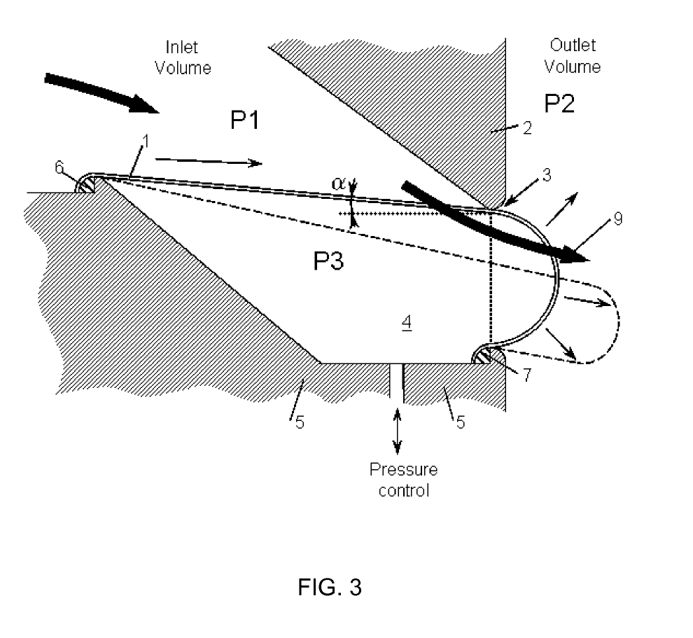

FIG. 3 is used to explain in more detail the principle of operation of the valve of the invention;

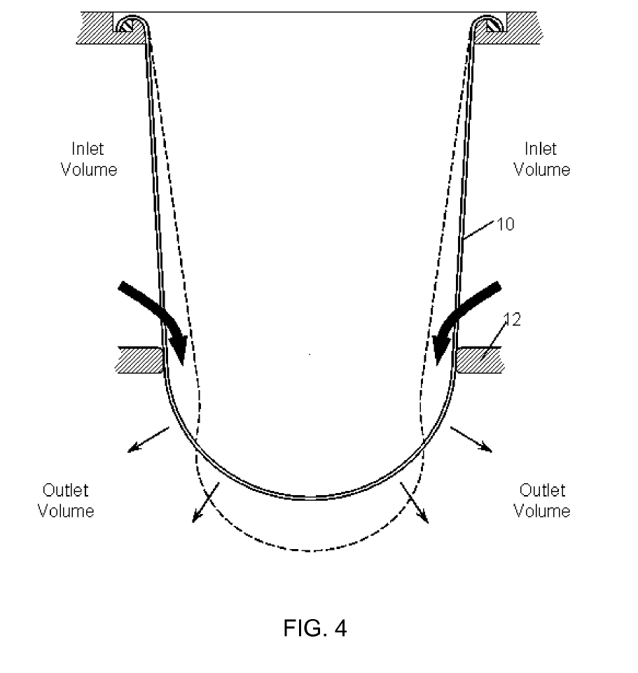

FIG. 4 shows a first example of implementation of valve of the invention;

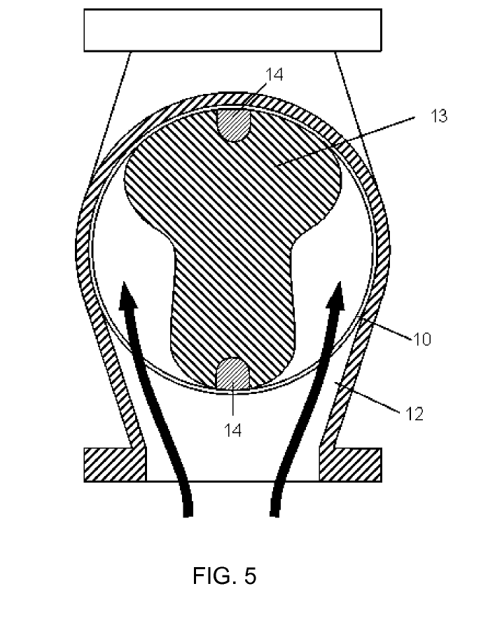

FIG. 5 shows a guide used to control the collapse of the diaphragm of FIG. 4;

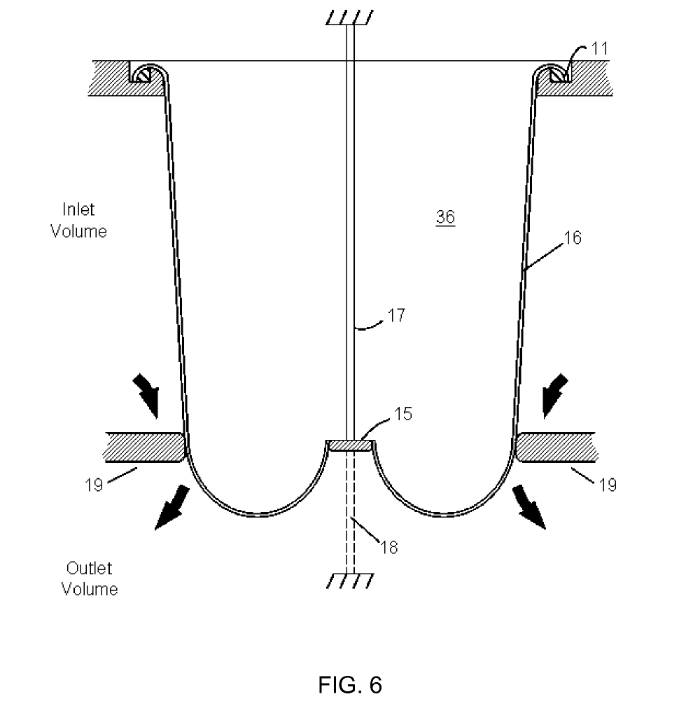

FIG. 6 shows another example of possible diaphragm design of the invention; and

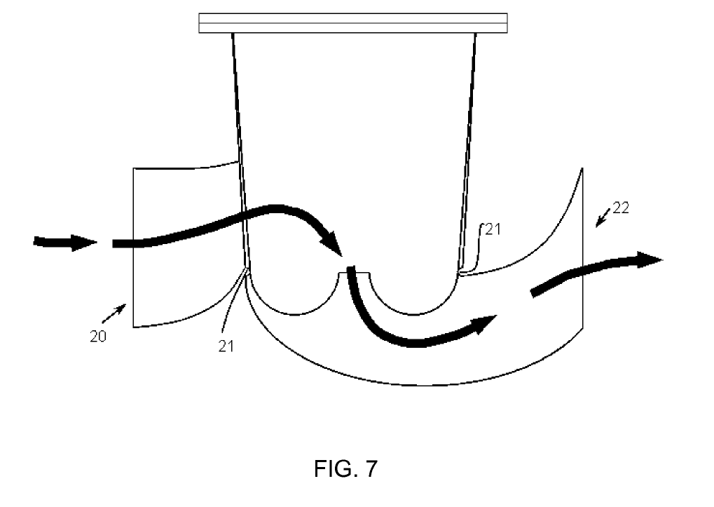

FIG. 7 shows an example of the valve based on the first example;

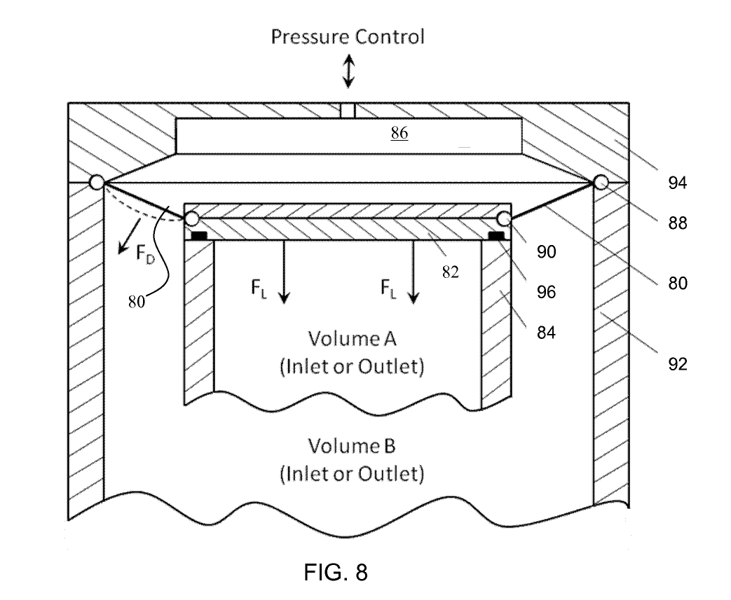

FIG. 8 shows a second example of implementation of valve of the invention when valve is in the closed state;

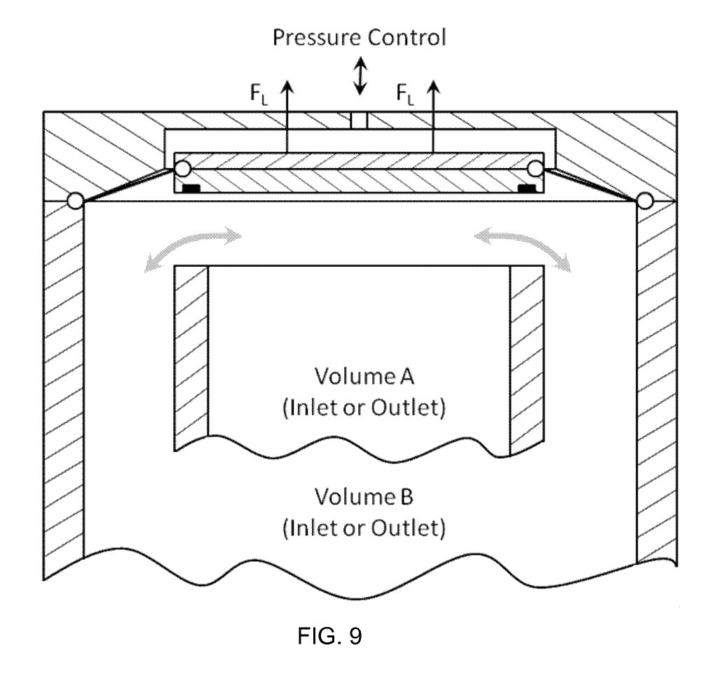

FIG. 9 shows the valve of FIG. 8 in the open state;

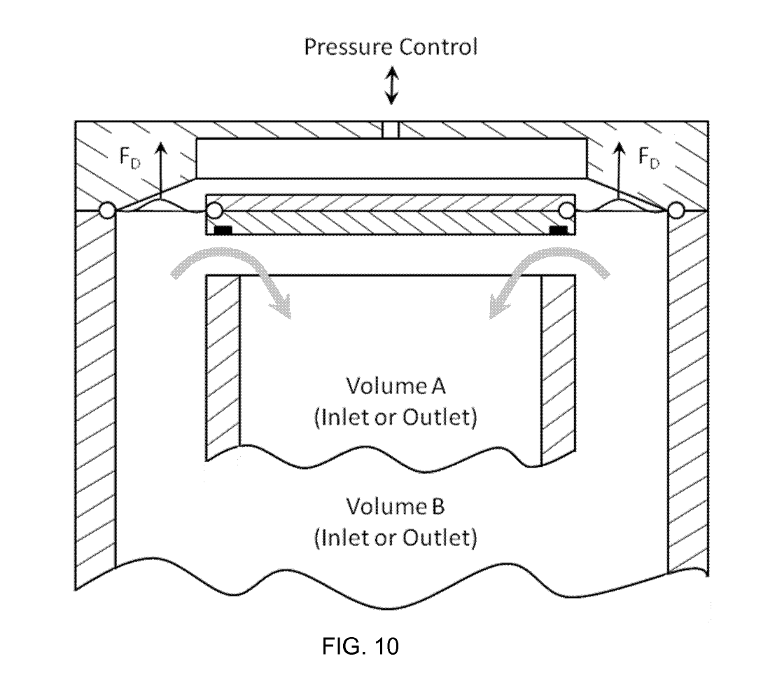

FIG. 10 shows the valve of FIG. 8 moving towards an open state;

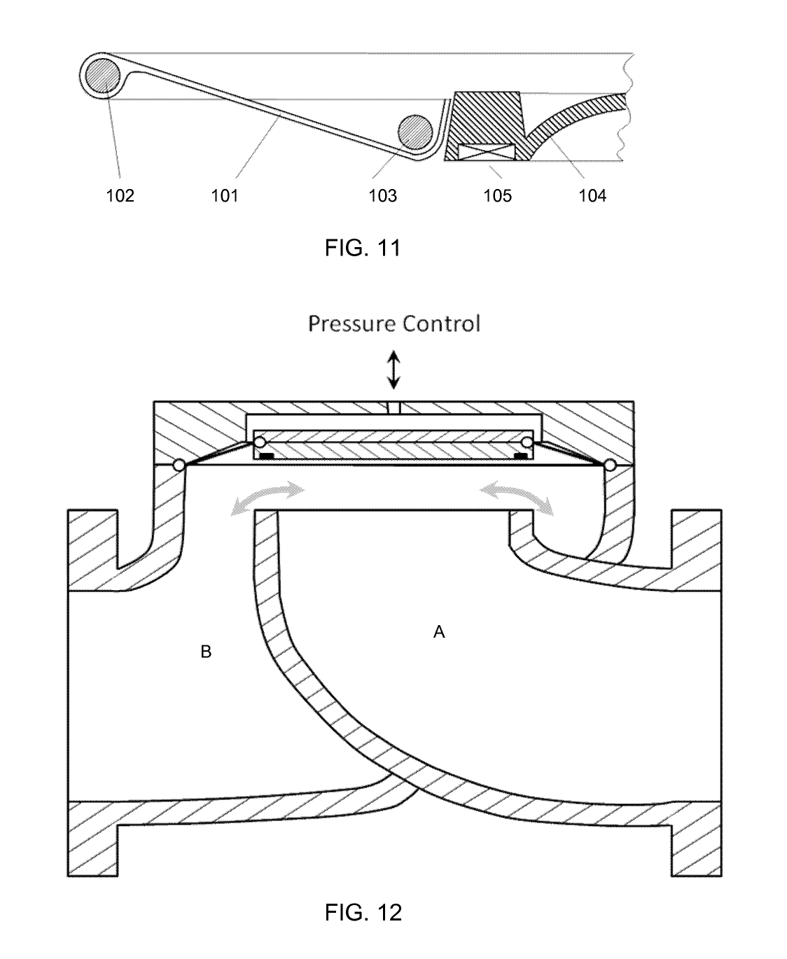

FIG. 11 shows in more detail a possible design of composite diaphragm; and

FIG. 12 shows an example of the valve based on the second example.

FIG. 2 is used to explain the general concept underlying the valve design of the invention. In this invention, the closing element is flexible, is fixed to the valve body, and is and mainly located in the high pressure area of the valve (the inlet side). This is opposite to conventional designs, in which a flow through the closing aperture (orifice) of the valve acts against the closing element, pushing it away from the closing aperture (orifice).

In the design of FIG. 2, the flow through the valve assists the valve closure, dragging (pulling) a closing element into the closing aperture (orifice) of the valve.

As shown in FIG. 2, the flexible closing element has closed state (solid lines) in which the element seals the orifice, and an open state (dotted lines) in which the element deforms to provide a passage between the inlet and outlet. The way the valve works will be described in detail below. Essentially, the pressure in the inner volume of the flexible element determines whether the valve is in the open or closed state.

FIG. 3 is used to explain the operation of the valve in more detail, and shows a cross section. The flow through the valve is controlled by a flexible diaphragm 1 that is reinforced with metal or polymer wires or fabric. The inlet volume has a pressure P1 and the outlet volume has a pressure P2. The inlet and outlet volumes of the valve are on the same side of the diaphragm which separates the two volumes. The pressure P1 is always higher than or equal to than pressure P2.

A part 2 of the valve housing, acting as a sealing member, provides a sealing point 3 on the same side of the diaphragm 1, and this sealing point separates the inlet and outlet volumes. As will become apparent from the description below, the sealing point in the preferred implementation is an annulus.

A control chamber 4 of the valve is formed on the opposite side of the membrane 1 by the membrane and other parts 5 of the valve housing. An internal pressure P3 inside the chamber can be controlled, and the pressure P3 is equal or less than pressure P1.

The ends of the diaphragm 1 are fixed with two solid elements (beads) 6 and 7 that provide an interface with other parts 5 of the valve housing. These elements 6,7 can be connected to and sealed with the valve housing parts 5 by a number of methods (clamped mechanically, sealed with O-ring cord etc.) which are not shown.

When the pressure P3 inside the chamber 4 is equal to the inlet pressure P1 (the chamber 4 is connected to the inlet volume) the valve will be closed because:

there are no forces applied to the diaphragm 1 between bead 6 and sealing point 3 that have a normal (orthogonal) component, as the pressures on both sides of the diaphragm are equal;

there are forces applied to the diaphragm 1 between the sealing point 3 and bead 7 that have a normal component that inflates (bulges) this part of diaphragm 1 out into the outlet volume, and these forces will urge the diaphragm 1 against the sealing member 2.

At the sealing point 3, all forces applied to the diaphragm 1 between the sealing point 3 and bead 7 will be transformed to a pure longitudinal force F that, acting along the diaphragm 1, will stretch it into a straight surface between the sealing point 3 and the bead 6. Metal or polymer fibres with a high tensile strength that reinforce the diaphragm 1 and fixed with the beads 6 and 7 prevent it from elongating.

A spatial location of the beads 6, 7 and the sealing member 2 as well as a length of the diaphragm 1 between the sealing point 3 and the bead 7 are important to provide a sufficient normal force between the diaphragm 1 and the sealing point 3, to ensure a reliable (tight) sealing.

For example, an angle a can be defined between the stretched diaphragm 1 and a line perpendicular to the line connecting the sealing point 3 and the bead 7. The larger this angle α, the larger the normal force that will be applied to the sealing point. An optimisation of surface configuration and the properties both of the diaphragm 1 and the sealing member 2 at the sealing point 3 will also strongly affect the quality of a sealing of the valve.

When the pressure P3 inside the control chamber 4 becomes less than the pressure P1, forces with a large normal (orthogonal) component are applied to a surface of the diaphragm 1, and these will push it away from the inlet volume towards the position shown in dotted lines in FIG. 3. This movement will result in a gap opening between the sealing member 2 and a surface of the diaphragm 1 so liquid media can flow through the gap from the inlet volume to the outlet volume of the valve, shown as 9.

The degree of opening of the valve will depend on the pressure P3 in the control chamber 4 relative to the pressures P1 and P2. As shown above, if the control chamber 4 is connected to the inlet volume, the valve will be closed. Similarly, if the control chamber 4 is connected to the outlet volume, the valve will be opened and a drop in pressure across the valve in this case will depend on configuration of constitutive parts of the valve and the length and flexibility/rigidity of the diaphragm 1.

The diaphragm 1 can be manufactured using a wide range of elastomers (rubbers, polyurethanes etc.) and reinforced with different fibers or woven structures of metal, carbon, Kevlar, Zylon etc. Different resilient elements (i.e. metal spring wires or ribbons) can be also impregnated in the diaphragm body to achieve desirable or optimised properties of the diaphragm.

The control chamber 4, inlet and outlet of the valve can be connected in a known way, so that the valve can function as a pilot operated pressure control valve. In such a pilot operated pressure control valve, a pressure in a control chamber controls the valve operation. The control chamber is not in the main fluid flow path. In one arrangement, when the pressure in the control chamber is equal to the inlet pressure, the valve is closed, as a result of differential areas (the control chamber pressure acts on a larger area than the area of a valve disc exposed to the inlet fluid flow). To open the valve, the pressure in the chamber is reduced so that the inlet fluid flow opens the valve (as shown in FIG. 1). To operate the valve design of the invention in this way, a pilot valve can control the coupling of the volume 4 to either the inlet or outlet pressure.

The diaphragm for the valve of the invention can be formed as a closed structure of different shape, for example, as a bowl shape 10 attached to a rigid upper outer rim/bead 11 as shown in FIG. 4. This particular design provides a simple component that can simply be dropped into a valve body from its top. An annular sealing member 12 can then be around the outside of the bowl 10. The fluid inlet volume is around the outside of the bowl 10 above the sealing member 12, and the fluid outlet volume is around the outside of the bowl 10 below the sealing member 12.

As shown in FIG. 5, a solid guide member 13 can be installed inside the bowl 10 and firmly attached to part of the valve housing (the valve top lid, for example) for controlling the deformation of the flexible diaphragm (the bowl) when the flow stream urges against the bowl 10 from the inlet volume. The bowl shaped diaphragm 10 collapses to move away from the sealing member 12, and this collapse can be controlled by the guide member 13 to protect the diaphragm (bowl) 10 from undesirable deformation and give the desired flow characteristics of the valve. The guide member 13 comprises a rigid surface with a designed shape against which the flexible diaphragm (bowl) 10 collapses.

Additional rigid elements 14 are shown in FIG. 5 that are firmly attached (for example chemically bonded) to the diaphragm (bowl) 10, and these ensure a required symmetrical form of the diaphragm under its deformation by the liquid media stream.

As shown in FIG. 6, the diaphragm can be formed as a bowl shape with a rigid upper outer rim 11 and also a rigid lower inner rim 15, and a flexible diaphragm 16 connecting the rims. The introduction of the inner rim 15 to the design allows a reduction in space required for the outlet volume and provides a component to which the ends of the fibers that reinforce the diaphragm bowl 16 can be attached. The inner rim 15 can be fixed to different parts of the valve housing (for example, by rod 17 and 18) or fixed with a guide member that is inserted inside the bowl and provides a rigid connection to the valve body. Similarly, in this design, the sealing member 19 is around the outside of the bowl 16. The inlet volume is around the outside of the bowl above the sealing member 19, and the outlet volume is around the outside of the bowl below the sealing member 19. This design also provides a component that can simply be dropped into place inside the valve body.

FIG. 7 shows an example of the valve of the invention using the diaphragm explained above. As shown, the fluid inlet 20 is above the sealing member 21 and the fluid outlet 22 is below the sealing member 21. The diaphragm(s) of this invention can have a different shape both in the inflated and collapsed states. In the collapse state of the diaphragm, its shape can be controlled by the guide member that, being installed inside the diaphragm, will protect it from undesirable deformations. The diaphragm preferably comprises a reinforced elastomer. Kevlar, carbon and Zylon fibers, or other reinforcing materials can be used.

The invention has been described above using examples of single direction flow control valves. The concepts underlying the invention can equally be applied to bidirectional valves. An example of bidirectional valve which operates using the same underlying concepts is shown in FIG. 8.

In this case, the valve cannot have fixed (assigned) inlet and outlet terminals because the liquid media flow direction can be changed at any time. Almost all flow control devices (valves) have a pressure drop even in the fully opened position when a liquid media flows through the valve. It is then appropriate to consider an inlet and outlet. The inlet is the region where liquid media flows into device or is a volume inside the device where a pressure is higher than at the outlet (at a particular point in time). The outlet is the region where liquid media flows from the device or is a volume inside the device where a pressure is lower than at the inlet.

The bidirectional capability is achieved by making two adaptations to the designs previously shown. The first adaptation concerns the orientation of the components.

In FIG. 8, the inlet and outlet volumes A and B are again on the same side of the diaphragm 80,82. A fixed seal part 84 defines the boundary between the two volumes, and is in the form of a cylinder (not necessarily circular) within the outer housing. The other side of the diaphragm 80,82 defines the control chamber 86. The components now define one volume (volume A) inside another (volume B), and the diaphragm functions as a lid which can open or close the inner volume (volume A) to connect it to the outer volume (volume B). Although this lid design is different in orientation to the examples above, the operation of the valve is the same, in that the inlet and outlet are on one side of the diaphragm and the control chamber is on the opposite side. Again, the pressures at the inlet and outlet are applied to a smaller area of the diaphragm that the area of the diaphragm to which the control chamber pressure is applied. It is these relative areas that enable control of the valve in the same way as described above. However, this design facilitates bidirectional capability of the valve.

The second adaptation concerns the design of the diaphragm. The diaphragm has a flexible outer part 80 and a rigid inner part 82. The inner part 82 functions as the lid for closing the inner volume A.

The diaphragm has an annular flexible diaphragm part 80 which is reinforced with metal or polymer wires or braided fabric. For example, the reinforcing wires may extend radially from the opening defined for the lid and the outermost rim. The annulus may be round, elliptical or other shape.

The outer edge of the flexible part 80 of the diaphragm is fixed with solid elements (beads) 88 with parts 92 and 94 of the outer housing of the valve. The inner edge of the flexible part 80 of the diaphragm is fixed with the solid elements (beads) 90 to the lid 82.

The connection and sealing between the flexible part 80 of the diaphragm and the lid and between the flexible part 80 of the diaphragm and the valve housing parts can be by a number of methods (clamped mechanically, sealed with O-ring cord etc.) which are not shown.

The multi-component diaphragm 80,82 can be manufactured together as a single item and this is discussed further below.

The solid lid part 82 has a sealing element 96 that provides a sealing point against the rim of the cylindrical seal part 84 (not necessary circular). The sealing element 96 acts against the surface of the seal part 84.

The control chamber 86 of the valve is formed by the side of the diaphragm (i.e. both the flexible part 80 and the rigid lid 82) on the opposite side to the inlet and outlet volumes. An internal pressure inside the control chamber can be controlled, for example by connecting this chamber 86 to the inlet or outlet of the valve.

The operation of the valve will now be explained. FIGS. 9 and 10 show the same valve design but with the lid part in different positions. The reference numbers of FIG. 8 are not repeated in FIGS. 9 and 10, but the components shown in FIGS. 9 and 10 are identical to FIG. 8 as will be immediately apparent.

The valve is closed if the control chamber 86 is connected to a volume with a relatively high pressure (for example the inlet pressure) and will be opened if the control chamber is connected to a volume with a relatively low pressure (for example the outlet pressure). This will be explained in further detail below.

Considering the two cases when the valve will be closed: when the volume A is the inlet and the volume B is outlet and vice versa (as shown in FIG. 8),

(i) Volume A is the inlet, Volume B is the outlet

The pressure in the volume A is then higher than the pressure in the volume B, and the control chamber is connected to the volume A. In this case, the pressures on the both sides of the lid 82 are equal so a resulting force F_{L} that can be generated as a function of the area of the lid and the pressure differences applied to the lid is equal to zero. At the same time, a pressure applied on the diaphragm from the chamber side 86 is higher than a pressure from the outlet volume side (volume, B). This pressure difference generates a force F_{D} applied to the diaphragm and directed towards the outlet volume B. Because the diaphragm is connected by one edge to the lid, it forces the lid down towards the seal part 84 of the valve housing closing the inlet volume by means of the sealing element 96.

(ii) Volume A is the outlet, Volume B is the inlet

The pressure in the volume A is lower than the pressure in the volume B and the control chamber is connected to the volume B. In this case, the pressure from the control chamber side 86 of the lid is higher than the pressure from the volume A side of the lid, and this pressure difference generates a force F_{L} applied to the lid and directed towards the outlet volume A. This force presses the lid down towards the part 84 of the valve housing closing the outlet volume A by the lid with the sealing element 96. The diaphragm has equal pressures at its both sides so a resulting force applied to the diaphragm is equal to zero so it does not affect the force F_{L} applied to the lid.

Considering the two cases when the valve will be open: when the volume A is the inlet pressure and the volume B is outlet and vice versa:

(iii) Volume A is the inlet, Volume B is the outlet

The pressure in the volume A is higher than the pressure in the volume B and the control chamber is connected to the volume B. In this case, the pressure from the volume A side of the lid 82 is higher than the pressure from the control chamber side 86 of the lid and this pressure difference generates a force F_{L} applied to the lid and directed outwards the outlet volume B. This force will move the lid away from the seal part 84 of the valve housing, keeping the valve opened, as shown in FIG. 10.

The pressure on the control chamber side of the diaphragm will also be less than the pressure on the opposite side of the diaphragm so the force generated by this pressure difference and applied to the diaphragm will be directed opposite the volume A and therefore also will assist to moving the lid away from the seal part 84 of the valve housing, and keep the valve opened.

(iv) Volume A is the outlet, Volume B is the inlet

A pressure in the volume A is lower than the pressure in the volume B and the control chamber is connected to the volume A. In this case, the pressures from the both sides of the lid are equal so a resulting force F_{L} that can be generated as a function of the area of the lid and the pressures difference applied to the lid is equal to zero. At the same time, a pressure applied on the diaphragm from the control chamber side is lower than a pressure from other side (inlet volume B). This pressure difference generates a force F_{D} applied to the diaphragm and directed towards the control chamber volume 86. Because the diaphragm is connected by one edge to the lid, it forces (lifts) the lid away from the seal part 84 of the valve housing.

The position of the lid in the closed position is shown in FIG. 8, the position of the lid in the open position is shown in FIG. 9, and the position half way between the open position and the closed position is shown in FIG. 10.

Thus, the bidirectional capability of the valve is shown.

The diaphgragm can be considered to be a closing element. This closing element can be a single component or it can have multiple parts, for example multiple layers. It can be manufactured by a number of ways. Providing a rigid lid part assists the sealing, because the shape of the seal 96 can be accurately matched to the shape of the seal part 84 to provide a reliable seal. The symmetry of the flexible diaphragm part 80 means the lid is lifted linearly, and tipping is avoided. Furthermore, the shape of the lid may be chosen to influence the stability of the movement of the lid. For example, the shape may induce a desired flow pattern between the inlet and outlet volumes. The lid may for example have a domed shape (which is partly shown in FIG. 11). The valve is stable in its open or closed state, and the shape of the housing parts can be chosen so that when in the open state, the lid is seated against part of the valve housing.

The preferred design of closing element of the valve is thus a flexible diaphragm and a rigid element. These can be manufactured as a single part as explained with reference to FIG. 11.

The diaphragm is formed from reinforcing metal or polymer wires or a braded fabric 101 and two annular solid elements (beads): an outer bead 102 and an inner bead 103. The wires or braided fabric are looped around the outer bead 102. The layers are brought close together so that they surround the bead. The free ends of both layers are bent around the inner bead 103 and clamped between the bead 103 and tapered outer edge of the lid 104. After assembly, the construction is wholly or partly covered by an elastomer, preferably using a chemical bonding agent(s) that assures a strong bond of the elastomer to the mechanical structure of the closing element.

The lid 104 has a groove with a sealing element 105 (this corresponds to item 96 in FIG. 8) that provides a reliable sealing with a part of the valve housing that acts as a sealing member.

To assure that the valve will operate reliably at all the time, a compression spring can installed in the control chamber 86 between the lid part 82 of the closing element of the valve and the top of the control chamber (spring not shown). This functions as a positive feedback element, to provide more bistable operation of the valve between the on and off states. However, the valve design can also be used to control the flow rate by applying an adjustable pressure to the control chamber, namely one which can be controlled to be a desired control pressure lying between the inlet and outlet pressures. This would enable the valve to be held in an intermediate state, such as shown in FIG. 10.

FIG. 12 shows an example of this embodiment of valve of the invention to show that the valve can be arranged in the same standard configuration as shown in FIG. 7. One of the volumes A and B is coupled to one side of the valve and the other volume is coupled to the other side of the valve. The control pressure port is on top of the valve housing.

As mentioned above, one application of this invention of particular interest is water control valves, for example used in the mains water system.

As mentioned above, a small pilot pressure regulating valve can be connected in a standard known way to the valve control chamber, so that connection to the fluid inlet or outlet will allow the vale to operate as a pilot-operated pressure control valve. This pilot pressure regulating control valve is not exposed to the fluid flow rates or volumes of the main valve and can therefore be a reliable low cost device. It can be mechanically operated or electrically operated.

As can be seen from description given above, particularly the first example of valve design of the invention can have many fewer components. At the limit, there may be two basic components of the main valve body—the housing which defines the two terminals which act as inlet or outlet as well as the sealing member, and the diaphragm. The diaphragm can simply be dropped into position to assemble the valve, and a lid can then hold the fixed parts of the diaphragm (the rims) in position. The pilot control valve can then be provided as an externally mounted component.

The example above is a valve. However, the invention applies more generally to flow control devices, i.e. any device which controls the passage of fluid from an inlet side to an outlet side. For example the invention can be applied to equipment where pressure is generated by a centrifugal force. Indeed, the valve can be used to control the flow of fluids or fluids which contain particulate material such as suspensions.

From the examples above, it will be clear that the diaphragm can be a wholly flexible, or partly flexible. In all cases, a surface of the diaphragm forms a seal, and this can be defined in a rigid shape using a rigid part of the diaphragm or it can be defined using a flexible part. This does not change the way the valve functions in terms of the control of the movement of the diaphragm using different relative pressures.

Various modifications will be apparent to those skilled in the art.

1. A flow control device, comprising:
an inlet side;
an outlet side; and
a sealing member between the inlet and the outlet side; and
a diaphragm,
wherein the diaphragm selectively opens or closes or control a degree of closure of an opening between the inlet and the outlet sides depending on the proximity of the diaphragm to the sealing member,
wherein the diaphragm comprises a first portion of one side of the diaphragm exposed to the inlet side fluid pressure, a second portion of the same side of the diaphragm exposed to the outlet side fluid pressure and the opposite side of the diaphragm exposed to a control fluid pressure, wherein the movement of the diaphragm between the open and closed states is governed by the inlet, outlet and control pressures which cause deformation of the diaphragm.

2. A flow control device as claimed in claim 1 comprising a valve with an inlet and an outlet, wherein the valve comprises:
the sealing member on a first side of the diaphragm, wherein the inlet and the outlet are both on the first side of the diaphragm on opposite sides of the sealing member;
a control chamber provided on the opposite, second side of the diaphragm,
wherein the diaphragm is deformable between a first position in which a pressure in the control chamber corresponding to the inlet pressure urges a portion of the membrane against the sealing member, and a second position in which the inlet pressure urges the portion of the membrane away from the sealing member to couple the inlet and outlet.

3. A flow control device as claimed in claim 1 or 2, wherein the diaphragm comprises a reinforced elastomer.

4. A flow control device as claimed in any preceding claim, wherein the diaphragm is fixed at its ends.

5. A flow control device as claimed in any preceding claim, wherein the diaphragm is formed as a bowl shape with a rigid upper outer rim and a rigid lower inner rim, and a flexible membrane connecting the rims.

6. A flow control device as claimed in claim 5, wherein the sealing member is around the outside of the bowl.

7. A flow control device as claimed in claim 6, wherein the inlet is around the outside of the bowl above the sealing member, and the outlet is around the outside of the bowl below the sealing member.

8. A flow control device as claimed in claim 5, 6 or 7, further comprising a guide member inside the bowl for controlling the deformation of the flexible membrane.

9. A flow control device as claimed in claim 8, wherein the guide member comprises a rigid surface against which the flexible membrane collapses.

10. A flow control device as claimed in any one of claims 1 to 4, wherein the diaphragm comprises a flexible part and a rigid part, wherein the rigid part makes contact with the sealing member in the closed state of the device.

11. A flow control device as claimed in claim 10, wherein the inlet side and outlet side are defined by a first annular passageway within a second annular passageway.

12. A flow control device as claimed in claim 11, wherein the rigid part comprises a lid for closing the first annular passageway.

13. A flow control device as claimed in any preceding claim, further comprising a pilot pressure control valve for selectively coupling the inlet and outlet to the control chamber.

14. A method of assembling a flow control device, comprising:
providing a casing defining an inlet, an outlet and a sealing member;
lowering a cup-shaped membrane into the case, the membrane defining a control chamber inside the cup and the fluid inlet and outlet on the outside of the cup separated by the sealing member.

15. A method of controlling fluid flow between an inlet and an outlet, comprising:
controlling the pressure in a control chamber, thereby to deform a diaphragm between first and second positions, wherein a sealing member, the inlet and the outlet are on a first side of the membrane, and the control chamber is on an opposite side of the diaphragm,
wherein the diaphragm is deformed between a first position in which a pressure in the control chamber urges the a portion of the diaphragm against the sealing member, and a second position in which the inlet pressure urges the portion of the diaphragm away from the sealing member to couple the inlet and outlet.
